(19) United States
(12) Patent Application Publication
(10) Pub. No.: US 2003/0134526 A1
(43) Pub. Date: Jul. 17, 2003

(54) Chip test device used for testing a chip packaged by ball grid array (BGA) technology

(76) Inventors: Wei-Jen Cheng, Shindian City (TW); Ching-Wen Deng, Junghe City (TW)

Correspondence Address: RABIN & BERDO, P.C., Suite 500, 1101 14th Street, N.W., Washington, DC, 20005, US

(21) Appl. No.: 10/317,103

(22) Filed: Dec. 12, 2002

(30) Foreign Application Priority Data
Jan. 15, 2002 (TW) 091100530

(51) Int. Cl. H01R 12/00

(52) U.S. Cl. 439/71

(57) ABSTRACT

A chip test device is provided for using a printed circuit board to perform a test process. The printed circuit board includes a pin probe socket having a plurality of pin probe holes. A chip to be tested includes a plurality of protruding electrodes. The chip test device comprises a test base for electrically coupled to the chip to be tested, a plurality of elastic first pin probes, and a test converting board having a first layer with a plurality of pin probe holes coupled to a corresponding one of the protruding electrodes and a second layer with a plurality of second pin probes coupled to a corresponding one of pin probes on the printed circuit board.

This application incorporates by reference of Taiwan application Serial No. 091100530, filed Jan. 15, 2002.

### BACKGROUND OF THE INVENTION

1. Field of the Invention

This invention relates to a chip test device, and more particularly, the invention relates to a chip test device, used for testing a chip that is packaged by a ball grid array (BGA) technology.

2. Description of Related Art

Generally, after the fabrication of a chip, it is necessary to perform the test procedure on the chip, so as to ensure that the chip can function correctly. Taking the central processing unit (CPU) as an example, most of the current CPU's manufactured by Intel, such as the Pentium III CPU, are packaged by the technology of pin probe grid array (PGA). This kind of CPU typically has a number of pin probes, which are arranged in an array manner. The conventional method of testing the CPU is first to affix a pin probe socket specifically designed for the CPU to a printed circuit board (or main board). Then, the CPU to be tested is plugged into the pin probe socket for testing. The test for the CPU is then performed by the electrical coupling between the pin probes of the CPU and the printed circuit board.

It is should be noted by the person skilled in the art that even though the CPU packaged by the PGA technology has the advantages of the possibility of upgrade, each CPU usually has a few hundred pin probes in rather high hardness and high density. Thus the fabrication cost for each pin probe is very expensive. Also, the possibility of upgrade for the CPU at some later time is not always a concern of every user. At the same time, it is also not satisfying the main trend of lower priced computers.

In order to reduce the fabrication cost, some CPU's, such as the Cyrix CPU's, are packaged by a technology of ball grid array (BGA). As a result, a large number of the expensive pin probes can be saved, the size can be reduced, and the pin probe socket can also be saved by directly connecting it to the main board via a surface mount technology (SMT). The CPU that is packaged by the BGA technology needs to use the main board in specific design, so that a number of pads can be disposed with respect to the pin probes.

Since the Intel Corporation is the largest manufacturer of the CPU, the manufacturers for the main board always make the effort to support the CPU provided by Intel. The main boards sold in the market usually have put the higher priority to be able to support the CPU of Intel. This would cause other CPU manufacturers to lose the market share. Further still, the CPU usually needs to be tested, and the time for the product being available in the market would usually be delayed by a few months.

Furthermore, from the point of view of the manufacturers in assembling the chipset, the designing ability and designing speed for the manufacturers in assembling the chipset in Taiwan have been gradually standing at the leading position in the world, comparing with the other manufacturers. It is now possible for the chipset being of the single same type to be able to support two or three types of CPU's at the same time, for example, the Intel and AMD types or the Intel and Cyrix types. Taking the levels for the Intel Pentium III as an example, the main board capable of supporting the Intel CPU has a socket 370 and the main board capable of supporting the AMD CPU has a socket A. However, the Cyrix CPU, which is characterized in a low price in design option, then can be disposed on the main board by the SMT manner. The manufacturer in the end needs to provide three kinds of specific main boards for supporting the three types of CPU's fabricated by the different manufacturers. When the test for the CPU is performed, the manufacturers of the CPU can buy a original socket from the market. Since the specific test pin probe socket used in the conventional method for testing the CPU has the difference with the pin probe socket on the original socket. This would cause that the conventional test pin probe socket for the CPU cannot be plugged onto the foregoing original socket. In addition, the specific test pin probe socket for the CPU has pin probes. The CPU manufacturers need to replace the pick socket of the original socket and a re-layout is then taken. In this manner, it would cause the increase of cost needed for testing the CPU. In addition, it would also consume the time for the extra design, and the fabrication time schedule is delayed. Further still, the action of replacing the original socket and performing the re-layout for the circuit would cause that the electrical property for this test main board may be not completely the same as that of the original main board. It is difficult to control the impedance for the main board. This would further cause that the precision of the signal being measured during the CPU test is reduced. Additionally, the action to replace the original socket and perform the design of circuit re-layout has a very high failing rate. Also, if the purchased original socket cannot be used or the CPU to be tested is damaged, the consumption for the related cost is quite high.

The conventional testing method for the chip is making use of replacing the original socket and performing the re-layout of the circuit, and then the test pin probe socket for the chip is affixed to the printed circuit board. However, the area of the test pin probe socket for the chip could differ from the area on the printed circuit board to adapt the chip. In addition, the layout manner for the pin probes of the test pin probe socket of the chip could differ from the original layout on the printed circuit board. This results in a higher failure rate for the conventional testing method. The uncertainty is also high. When problems occur, it is also difficult to figure out what is the root cause of the problems.

In summary, the conventional method for testing the chip with respect to the chip, which is packaged by the technology of ball grid array, has the following several disadvantages:

1. It would consume high testing cost and much time.

2. The precision for the measured results is not sufficiently high.

3. It is not possible to perform the test directly using the original socket purchased from the market.

### SUMMARY OF THE INVENTION

It is therefore an object of the present invention to provide a chip test device, which can be used to perform the test on the chip that is packaged by the technology of ball grid array. As a result, at least the following objects can be achieved:

1. It would save the consumption of cost and time.

2. The precision for the measured results is improved.

3. It is possible to perform the test directly using the original socket purchased from the market.

In accordance with the objects of the present inventions, a chip test device is provided for using a printed circuit board to perform a test process. The printed circuit board includes a pin probe socket having a plurality of pin probe holes. A chip to be tested includes a plurality of protruding electrodes. The chip test device comprises a test base for electrically coupled to the chip to be tested, a plurality of elastic first pin probes, and a test converting board having a first layer with a plurality of pin probe holes coupled to a corresponding one of the protruding electrodes and a second layer with a plurality of second pin probes coupled to a corresponding one of pin probes on the printed circuit board.

According to the chip test device of the present invention, the chip to be tested can be electrically coupled to the pin probe socket, and then the test for the chip can be performed by using the original socket that is purchased from the market.

### BRIEF DESCRIPTION OF DRAWINGS

The invention can be more fully understood by reading the following detailed description of the preferred embodiments, with reference made to the accompanying drawings, wherein:

FIGS. 1A and 1B are the perspective exploded drawings, schematically illustrating the structures of the component members of the chip test device, according to the preferred embodiment of the present invention;

FIG. 2 is a drawing of a top view of the test converting board as shown in FIG. 1A;

FIG. 3 is a drawing of the cross-sectional view, schematically illustrating the structure of the elastic pin probes as shown in FIG. 1A;

FIGS. 4A, 4B, and 4C are drawings of a side cross-sectional view, schematically illustrating a coupling manner between the elastic pin probes and the test converting board, according to the preferred embodiment of the present invention;

FIGS. 5A and 5B are drawings, schematically illustrating the coupling manner for the elastic pin probes and the test substrate for the chip to be tested and the test affixing base in various forms, according to the preferred embodiment of the present invention; and

FIG. 6 is a drawing of the side cross-sectional view, schematically illustrating the coupling manner between the chip to be tested, the test affixing base, the test converting board, and the pin probe socket, according to the preferred embodiment of the present invention.

### DETAILED DESCRIPTION OF PREFERRED EMBODIMENTS

The feature of the present invention is to provide a chip test device, which uses the elastic pin probes, so that each one of the protruding electrodes on the chip to be tested can be coupled to the test substrate. In addition, through the test converting board, it only needs to use the original socket sold in the market and the pin probe socket thereof, and then a test on the chip that is packaged by the technology of ball grid array (BGA) can be performed.

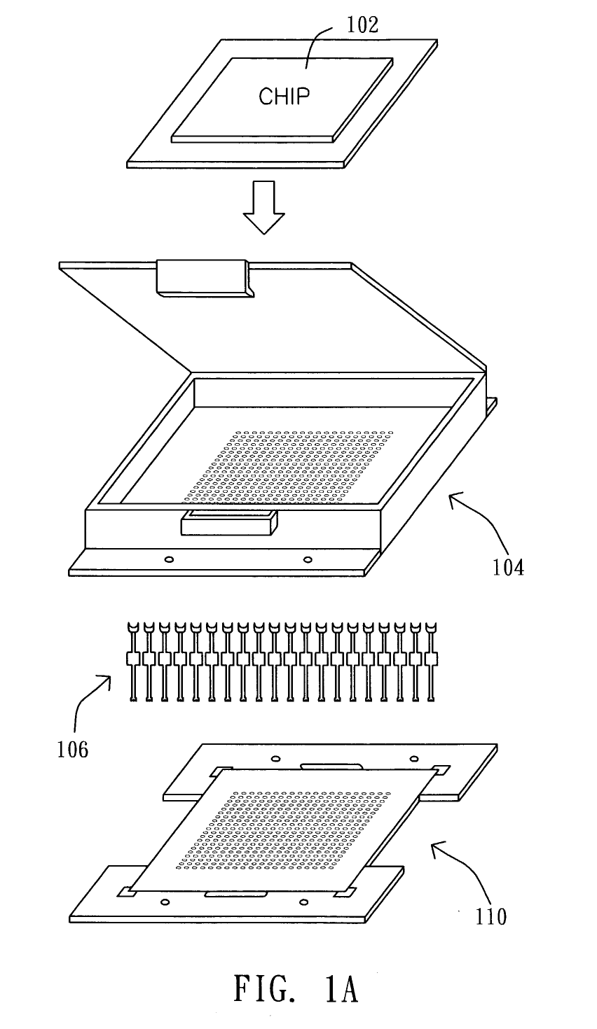

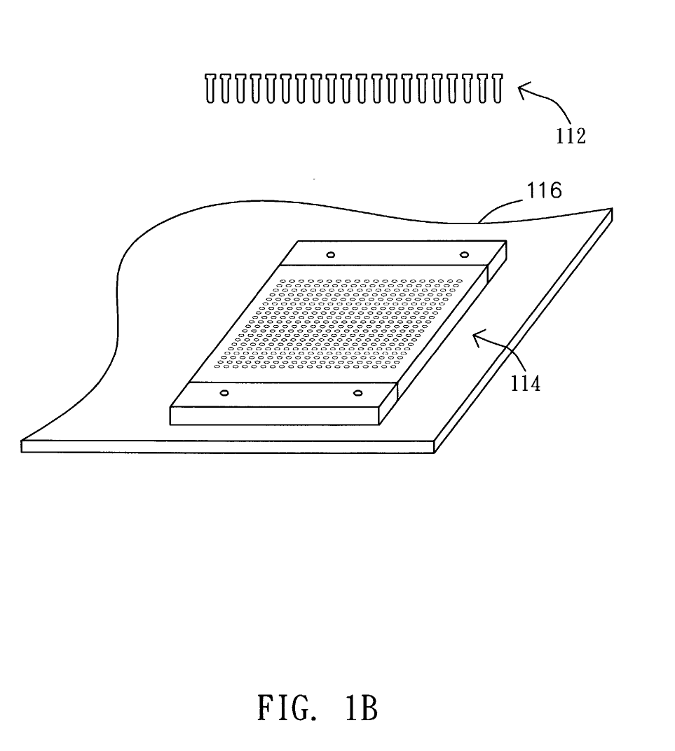

Referring to FIGS. 1A and 1B, they are the perspective exploded drawings, schematically illustrating the structures of the component members of the chip test device, according to the preferred embodiment of the present invention. The chip test device in the embodiment is formed by the sequential connection from the top to the bottom for the members of a test affixing base 104, an elastic pin probe 106, a test converting board 110, and a converting pin probe 112. By the chip test device, the printed circuit board 116 generally sold in the market with the socket 114 (that is the original socket sold in the market) then can be simply used for performing the test on the chip 102 packaged by the BGA technology. The structure shape and the coupling method in relation for each structure member of the chip test device in detail are described in the following.

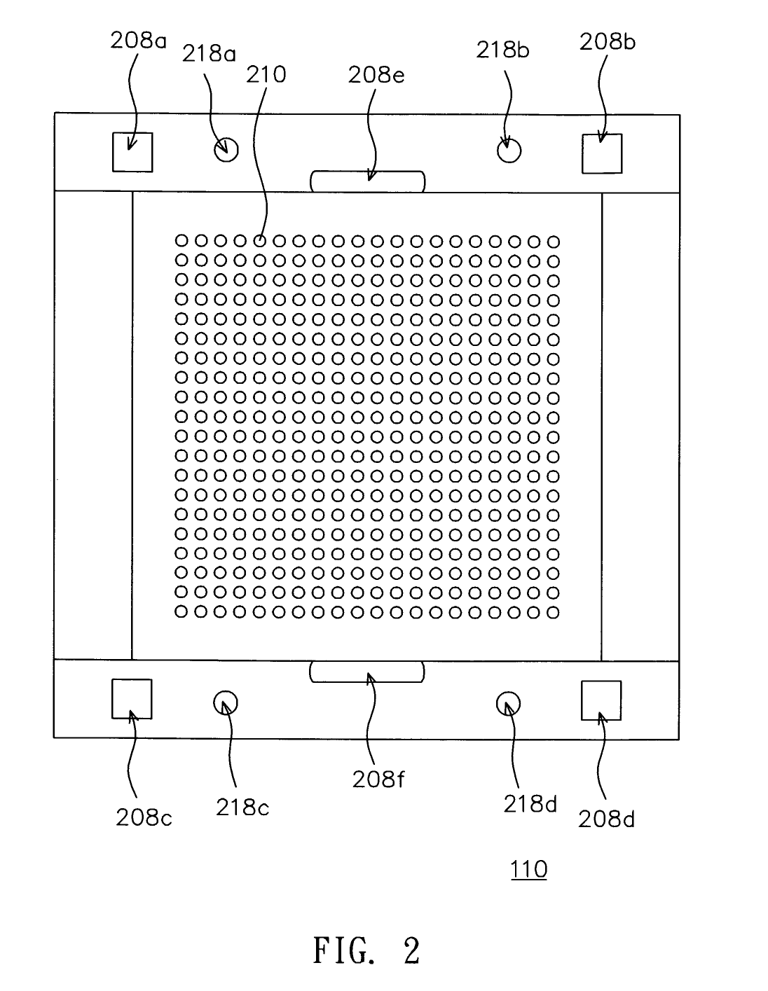

Referring to FIG. 2, it is a drawing of the top view of the test converting board as shown in FIG. 1A. The test converting board 110 is used to be separately coupled with the chip to be tested and the printed circuit boardsocket (not shown in FIG. 2). The test converting board 110 can have a number of windows 208a, 208b, 208c, 208d, 208e, and 208f, which are used to make the alignment for the printed circuit board. In other words, when the user intends to couple the test converting board 110 with the printed circuit board, the windows 208 can be used to align the marking line of the printed circuit board (not shown in the drawing), wherein the marking line is used to indicate the correct position of the chip to be tested, so that precise alignment can be achieved. In addition, the test converting board 110 can include a few locking holes 218a, 218b, 218c, and 218d; which are used to firmly mount the test affixing base 104 (not shown in the drawing) onto the test converting board. The function of the test affixing base is described as follows.

Further still, the test converting board 110 can include a number of pin probe holes 210. Each pin probe hole 210 is implemented with a pin probe (not shown in the drawing), whereby the test converting board 110 can be separately coupled to the chip to be tested and the printed circuit board via the pin probes. It should be noted that the disposed manner for the pin probe holes 210 on the test converting board 110 is made according in the same manner as for disposing the protruding electrodes of the chip that is packaged by the BGA technology.

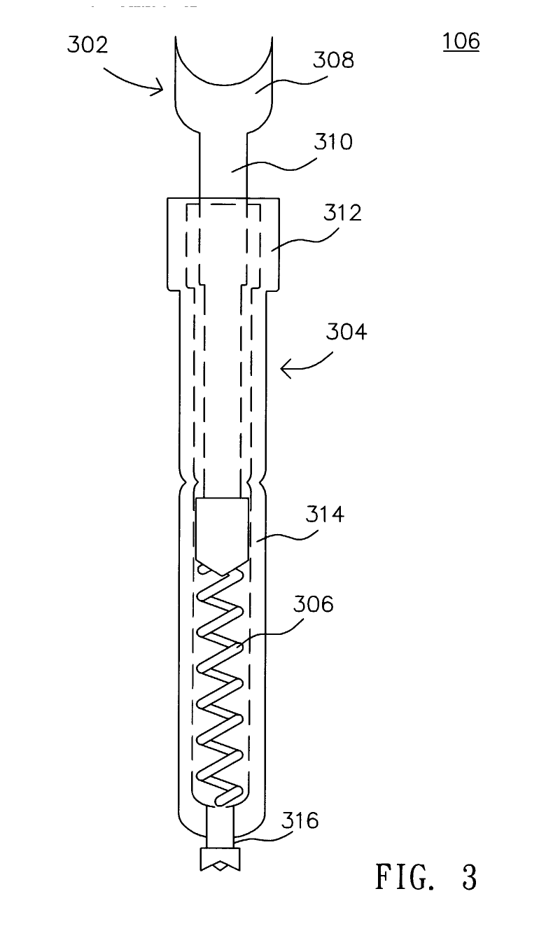

Referring to FIG. 3, it is a drawing of a cross-sectional view, schematically illustrating the structure of the elastic pin probes as shown in FIG. 1A. The pin probes used by the chip test device of the present invention are the elastic pin probes 106. Each of the pin probes 106 includes an upper pin portion 302 and a lower pin portion 304. The upper pin portion 302 is implemented by plugging into the lower pin portion 304, and the upper pin portion 302 is an elastic body, such as a spring 306, so as to be coupled with the lower pin portion 304. In this manner, the length of the elastic pin probe 106 can be changed according to the strength of the exerting force on the elastic pin probe 106.

The upper pin portion 302 further includes a pin probe head 308 with a concave surface and a rod part 310. The pin probe head 308 with the concave surface can allow the elastic pin probe 106 to have a better electrical connection with the protruding electrode of the chip to be tested packaged by the BGA technology. Also, the lower pin portion 304 includes a ring protruding part 312, a tube part 314, and a coupling part 316. The ring protruding part 312 is used to allow the elastic pin probe 106 to be affixed to the test converting board. The tube part 314 is used to allow the rod part 310 and the spring 306 of the upper pin portion 302 to be disposed thereon. The rod part 310 is coupled to the tube part 314 via the spring 306. The coupling part 316 is used to allow the elastic pin probe 106 to be coupled to the test converting board. In other words, the chip to be tested is coupled to the test converting board via the elastic pin probes.

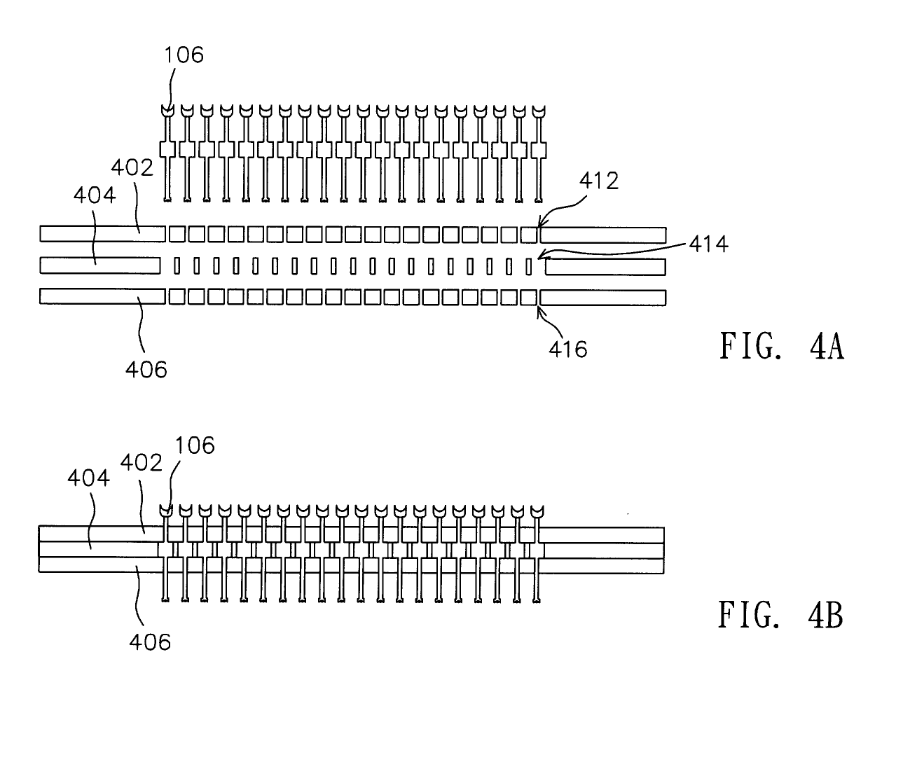

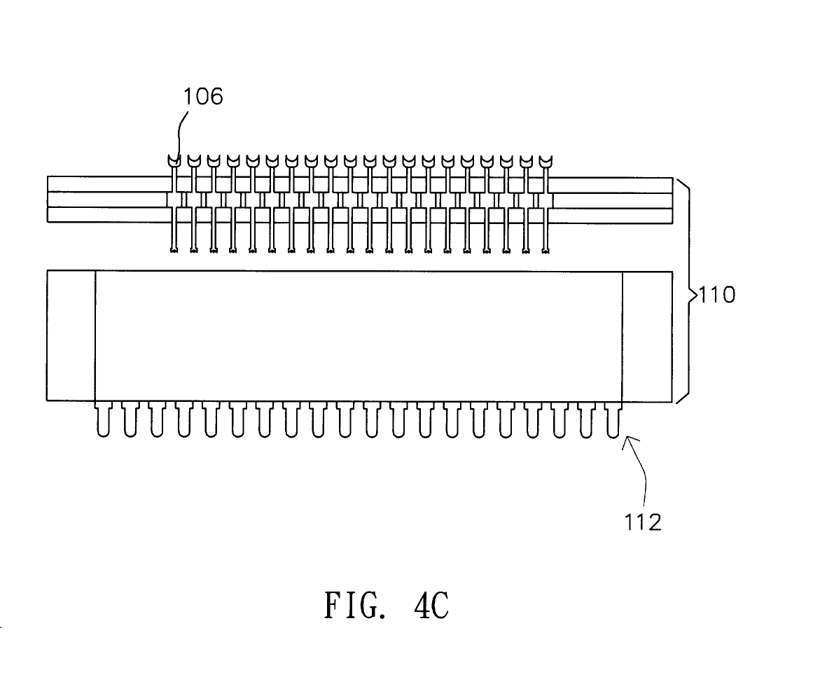

Referring to FIGS. 4A, 4B, and 4C at the same time, they are drawings of a side cross-sectional view, schematically illustrating a coupling manner between the elastic pin probes and the test converting board. The upper portion of the test converting board preferably includes a laminated substrate with three layers respectively of a first substrate layer 402, a second substrate layer 404, and a third substrate layer 406. The first substrate layer 402, the second substrate layer 404, and the third substrate layer 406 separately have the first layer holes 412, the second layer holes 414, and the third layer holes 416 with respect to each one of the pin probe holes 210 at the corresponding positions, so that the elastic pin probe can be thereby affixed onto the test converting board.

Referring to FIG. 3 and FIG. 4A at the same time, the method for affixing the elastic pin probe 106 onto the test converting board 110 is as follows. Since the rod part 310, the ring protruding part 312, and the tube part 314 have different diameters, they can use the different diameters of the first layer holes 412, the second layer holes 414, and the third layer holes 416 of the first substrate layer 402, the second substrate layer 404 and the third substrate layer 406, so as to achieve the purpose for affixing the elastic pin probes 106. The affixing method is that first, the tube part 314 of the elastic pin probes 106 is plugged into the third layer hole 416 of the third substrate layer 406. At this moment, the ring protruding part 312 is located above the third substrate layer 406. Then, the second layer hole 414 of the second substrate layer 404 is fit to the ring protruding part 312. Next, the first layer hole 412 of the first substrate layer 402 is fit to the rod part 316, and the purpose for affixing the elastic pin probes 106 is then achieved.

Since the elastic pin probe has the elastic property, its length can be changed according the degree of the exerting force. Therefore, each protruding electrode on the chip to be tested can be respectively engaged to the corresponding one of the elastic pin probes. It should be noted that even though the preferred embodiment is taking three substrate layers for the test converting board 110 and the elastic pin probes 106 as the example for descriptions, the actual applications of the present invention are surely not only limited to the embodiment. It has been sufficient for the scope to cover any method or structure that is able to affix the pin probe to the test converting board 110 and allow each protruding electrode of the chip 102 to be respectively coupled to the corresponding one of the elastic pin probes.

Referring to FIG. 4C, the test converting board 110 preferably includes six substrate layers, in which the top three substrate layers, as shown in FIGS. 4A and 4B, are disclosed above. In addition, the lower portion of the test converting board 110 is coupled with a number of converting pin probes 112 by the manner of the surface mount technology (SMT). The converting pin probes 112 are the usual pin probes for the chip that is packaged by the technology of pin probe grid array (PGA). The layout of the converting pin probes 112 is designed in a manner according to the layout for the holes of the pin probe socket 114 (not shown in the drawing) on the printed circuit board generally sold in the market. In other words, each converting pin probe 112 on the test converting board 110 is coupled with respect to the corresponding one of the pin probe holes on the pin probe socket 114, in which the pin probe socket 114 has the usual form of the pin probe socket often seen in the market, such as the type of socket 370.

According to the foregoing descriptions, when the chip is under testing, for the chip packaged by the technology of ball grid array, the area and the layout manner of the protruding electrode for the chip are different from the area of the pin probe socket and the layout manner of the pin probes on the printed circuit board usually sold in the market. For this reason, the chip cannot be directly coupled to the usual printed circuit board. In addition, most of the printed circuit boards usually sold in the market are suitable for use in coupling with the pin probes of the chips. The printed circuit board being able to be coupled with the protruding electrodes is necessary to be specifically designed. Chip test device provided by the present invention has the feature that it allows the printed circuit board usually sold in the market to be directly used to perform the chip test on the chip that has protruding electrodes.

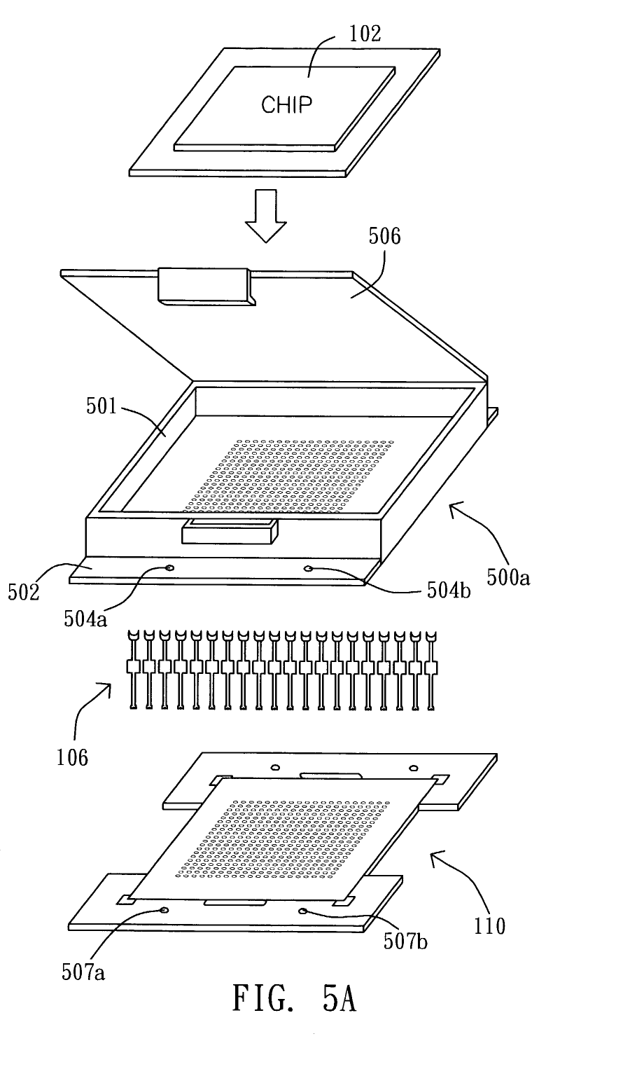

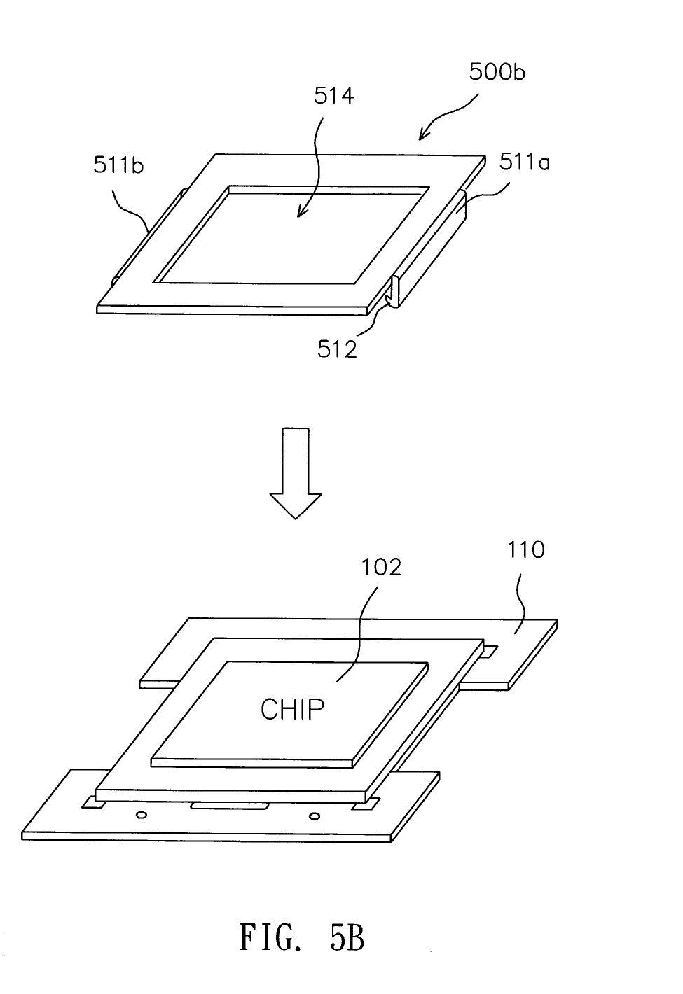

Referring to FIGS. 5A and 5B, they are drawings, schematically illustrating the coupling manner for the chip to be tested 102, the test affixing base 104, the elastic pin probe 106, and the test converting board 110 in various forms. After the elastic pin probes 106 and the test converting board 110 have been coupled, the chip 102 to be tested that is packaged by the technology of ball grid array can use the number of the protruding electrodes to be respectively coupled to the corresponding elastic pin probe 106 at the concave surface of the pin head. In order to improve the stability for the coupling between the chip 102 to be tested and the test converting board 110, the chip test device of the embodiment further includes a test affixing base 104, which can be used to allow the chip 102 to be tested to be stably coupled to the test converting board 110. As shown in FIG. 5A, the test affixing base is the affixing base 500a at the top cover. The affixing base 500a at the top cover includes an affixing base body 501. The top cover 506 is affixed to the affixing base body 501 in a rotatable manner. The affixing base body 501 is a cavity structure and can be used to adapt the chip 102 to be tested. After the affixing base 500a at the top cover is affixed to the test converting board 110, the affixing base body 501 can allow the chip 102 to be tested and the test converting board 110 to be electrically coupled together. In addition, the screw holes 504a and 504b may be implemented on the side plate 502 located at each side of the affixing base 500a at the top cover.

When the chip is under testing, the affixing base 500a at the top cover is affixed to the test converting board 110, and then the chip 102 to be tested is disposed on the affixing base body 501 of the affixing base 500a at the top cover, so as to perform the test on the chip 102 to be tested. The affixing base 500a at the top cover can be affixed securely to the test converting board 110 by using screws (not shown in the drawing) through the screw holes 504a and 504b of the affixing base 500a at the top cover and the locking holes 507a and 507b of the test converting board 110.

FIG. 5B is a drawing, schematically illustrating another form for the test affixing base. The affixing base 500b with a ring engage member includes a hollow region 514 and a pair of elastic side boards 511a and 511b having a buckling member 512. When the chip is under testing, the chip 102 to be tested is disposed on the test converting board 110 as shown in FIG. 5B. Then, the affixing base 500b with a ring engage member is pressed down. During the process of pressing down the affixing base 500b by the ring engage member, the elastic side boards 511a and 511b with the buckling member 512 are respectively bent toward the two sides until the affixing base 500b by the ring engage member is pressed down so that the buckling member 512 of the elastic side boards 511a and 511b with the buckling member 512 can hook the test converting board 110. By the buckling member 512 of the elastic side boards 511a and 5112a, the affixing base 500b by the ring engage member can be engaged with the test converting board 110 by the buckling manner, and the chip 102 to be tested can thereby be affixed between the affixing base 500b by the ring engage member and the test converting board 110.

It should be noted that these embodiments take the test affixing bases in two forms as examples for description. However, the present invention in the practical applications can be designed into various other forms, according to the actual needs for testing the chip. It has been sufficient in requirement with the function that the chip to be tested can be coupled to the test substrate.

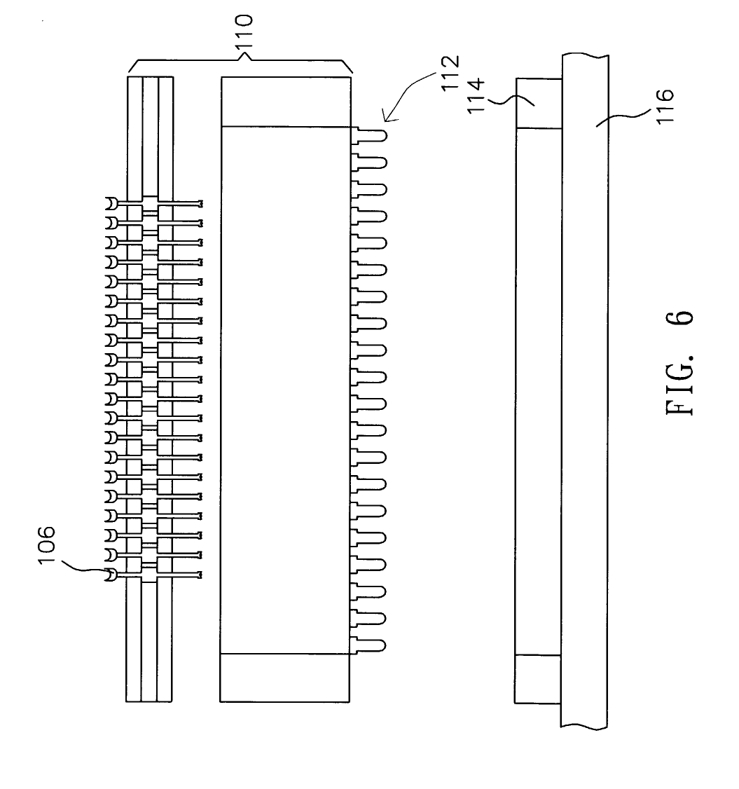

Referring to FIG. 6, it is a drawing of the side cross-sectional view, schematically illustrating the coupling manner between the chip to be tested, the test affixing base, the test converting board, and the pin probe socket, according to the preferred embodiment of the present invention. The test converting board 110 preferably has six substrate layers. However, other number of substrate layers can also be used, for example: four layers. By proper design of the circuit layout for each substrate layer, each pin probe hole (not shown in the drawing) on the top substrate layer of the test converting board 110 has a conductive path with respect to the corresponding one of the converting pin probes 112. In other words, each elastic pin probe 106 can be coupled to the corresponding one of the converting pin probes 112 on the test converting board 110 via the conductive path on the test converting board 110. Due to the test converting board 110, it can allow that the chip packaged by the technology of the ball grid array is capable of being coupled with the printed circuit board with the pin probe socket having a different area and a different layout manner. As a result, it will be very convenient that the main board usually sold in the market can be used to perform the chip test.

While the chip test is performing, the test affixing base 104, the elastic pin probes 106, and the test converting board 110 having the converting pin probes 112 can be sequentially coupled to the printed circuit board 116 at the pin probe socket 114. In this manner, the chip 102 to be tested can be directly affixed onto the affixing base body, and the chip test is then performed. The operation manner is simple and fast, and is quite suitable to be operated by a machine or an operator at the production line of the chip in mass production.

In summary of the effect achieved by the present invention, the embodiments of the present invention have disclosed the chip test device, that uses the elastic pin probes, to allow each protruding electrode of the chip, which is packaged by the BGA technology, to be coupled to the test substrate. Further still, due to the test converting board, it only needs to use the main board usually sold in the market and the pin probe socket, and then the chip, packaged by the BGA technology can be tested. As a result, it can save the testing cost and the testing time. Further still, it can also improve the conventional method's disadvantage of poor precision in the test results.

The chip test device of the present invention does not require damaging the original socket or taking the design for the circuit re-layout. It can also assure that the original socket purchased from the market can maintain the original electric property in the optimized condition. The reliability is then high. Also, when comparing with the properties of the damage and the re-layout for the circuit, the design disclosed by present invention and the testing procedure can greatly improve the success rate.

The chip test device of the present invention has the advantage that it is not necessary to damage and take a re-layout for the circuit. The present invention can also allow, for example, a Cyrix CPU with the converting board, and the corresponding pin probes, which have been already well tested in quality, can be directly plugged into the pin probe socket, such as the socket 370, on the main board. This can be used by the manufacturers who are requested to send the products to the users. It is also very practical and useful for the CPU of Intel, which is often in short market supply.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A chip test device, using a printed circuit board to perform a test process, wherein the printed circuit board includes a pin probe socket having a plurality of pin probe holes, and a chip to be tested includes a plurality of protruding electrodes, the chip test device comprising of:
a test base for electrically coupled to the chip to be tested;
a plurality of elastic first pin probes; and
a test converting board, having a first layer with a plurality of pin probe holes coupled to a corresponding one of the protruding electrodes, and a second layer with a plurality of second pin probes coupled to a corresponding one of pin probes on the printed circuit board.

2. The chip test device as recited in claim 1, wherein the second pin probes are affixed to the test converting board by a manner of surface mount technology (SMT).

3. The chip test device as recited in claim 1, wherein the test converting board is composed of six substrate layers.

4. The chip test device as recited in claim 1, wherein the chip to be tested is packaged by using a technology of ball grid array (BGA).

5. The chip test device as recited in claim 1, wherein the printed circuit board is a main board.

6. The chip test device as recited in claim 1, wherein the pin probe socket includes a type of socket 370.

7. A test converting board with a top surface and a bottom surface for electrically coupling a chip to be tested with a pin probe socket, comprising of:
a plurality of first pin probe holes in the top surface coupled to a corresponding protruding electrode of the chip to be tested,
at least one substrate layer for electrically coupling corresponding the first pin holes in the top surface with the bottom surface; and
a plurality of second pin probes in the bottom surface coupled to a corresponding one of pin probes on the pin probe socket.

8. The test converting board as recited in claim 7, wherein the second pin probes are affixed to the test converting board by a manner of surface mount technology (SMT).

9. The test converting board as recited in claim 7, wherein the test converting board is composed of six substrate layers.

10. The test converting board as recited in claim 7, wherein the chip to be tested is packaged by using a technology of ball grid array (BGA).

11. The test converting board as recited in claim 7, wherein the pin probe socket includes a type of socket 370.

12. A test converting board with a top surface and a bottom surface for electrically coupling a BGA packaged chip to be tested with a pin probe socket, comprising of:
a plurality of first pin probe holes in the top surface coupled to a corresponding protruding electrode of the BGA packaged chip to be tested;
at least one substrate layer for electrically coupling corresponding the first pin holes in the top surface with the bottom surface; and
a plurality of second pin probes in the bottom surface coupled to a corresponding one of pin probes on the pin probe socket.
